(19) United States
(12) Patent Application Publication
(10) Pub. No.: US 2024/0414439 A1
(43) Pub. Date: Dec. 12, 2024

(54) METHODS OF AND SYSTEMS FOR ROBOTIC INSPECTION

(71) Applicant: Kitov Systems Ltd, Petach Tikva (IL)

(72) Inventors: Yigal KATZIR, Rishon-LeZion (IL); Gilad FURST, Nes-Ziona (IL); Nir AVRAHAMI, Hertzeliya (IL); Tamir MARGALIT, Moshav Mazor (IL)

(73) Assignee: Kitov Systems Ltd, Petach Tikva (IL)

(21) Appl. No.: 18/697,493

(22) PCT Filed: Oct. 3, 2022
(86) PCT No.: PCT/IL2022/051056

§ 371 Date: Apr. 1, 2024

Related U.S. Application Data
(60) Provisional application No. 63/251,646, filed on Oct. 3, 2021.

(51) Int. Cl. H04N 23/68; G06T 7/00; G06T 7/246; H04N 23/667

(52) U.S. Cl. CPC H04N 23/682; G06T 7/001; G06T 7/248; H04N 23/6811; G06T 2207/10152; G06T 2207/30108; H04N 23/667

(57) ABSTRACT

A method of inspecting an object of manufacture, the method including: receiving: a model of the object of manufacture, the model including one or more feature of a region of interest (ROI) of the object of manufacture; and inspection requirements including a specification of required quality of image data of the ROI; moving an imager with respect to the object of manufacture, while acquiring at least one image of the ROI using the imager, wherein the moving is controlled so that the at least one image provides the required quality of image data of the ROI; extracting one or more feature of the ROI, from the at least one image; and comparing the one or more feature of the ROI with a corresponding one or more feature of the model.

### RELATED APPLICATIONS

This application claims the benefit of priority of U.S. Provisional Patent Application No. 63/251,646 filed Oct. 3, 2021, the contents of which are incorporated herein by reference in their entirety.

### FIELD AND BACKGROUND OF THE INVENTION

The present invention, in some embodiments thereof, relates to methods of and systems for inspection and, more particularly, but not exclusively, to method of and systems for optical inspection of objects.

U.S. Pat. No. 9,393,696 discloses “A robot system includes a robot body, a camera mounted on the robot body and capable of photographing a work piece; and a control device for driving and controlling the robot body based on a trajectory to an instruction point, which is set in advance, and, when the camera arrives at an area in which the camera is capable of photographing the work piece during this driving and controlling, driving and controlling the robot body so that the camera moves linearly toward the work piece, taking an image of the work piece with the camera while the camera is moving linearly, and measuring a position of the work piece from the taken image.”

U.S. Pat. No. 6,864,498 discloses “A scanner system acquires images of articles using a sensor acquiring an image of a portion of an article and defining a field of view, a displacer operative to provide mutual relative displacement between the article and the sensor at a generally uniform rate of displacement, and a field of view freezer operative to provide a generally motionless image during image acquisition. The scanner system is particularly useful in the field of automated optical inspection.”

U.S. Patent Application Publication No. US2019/0184582 discloses “An imaging device includes a camera, a robot that moves the camera, and a controller that processes an image. A detection surface defined on a workpiece and a set position serving as an imaginary position of the robot for detecting the workpiece are determined in advance. The camera captures a plurality of first images at a plurality of positions. The controller includes an image conversion unit converting the plurality of the first images into a plurality of second images when captured at the set position. The controller includes a composition unit generating a composite image into which the plurality of the second images are composited, and a composite image processing unit performing at least one of detection and inspection of the workpiece on the detection surface on the basis of the composite image.”

Japanese Patent Document No. JP2010131685A discloses “PROBLEM TO BE SOLVED: To obtain an image of an object with little blur during movement of a robot arm. SOLUTION: A robot system includes: robot arms 23 and 25 having a picking hand 26 capable of holding the object 5 with the picking hand 26 provided to be movable; an imaging device 30 provided in the vicinity of the picking hand 26 to pick an image of the object 5 and to be movable; a sensor posture controller for controlling a posture of the imaging device 30 in association with the movement of the robot arms 23 and 25; an image processor capable of obtaining a position and a posture of the object 5 based on the image picked up by the imaging device 30; and a robot controller for controlling the picking hand 26 to bring the robot arm 25 close to have the object 5 held based on the position and the posture of the object 5 obtained by the image processor. The imaging device 30 changes the posture while capturing the object 5 as the robot arm 25 moves in holding the object 5 and picks up the image of the object 5.”

Additional background art includes “MECHANICAL FMC TECHNIQUES FOR REMOVING IMAGE BLUR IN DIGITAL AERIAL CAMERAS” by O. Selimoglu, O. Yilmaz, O. Şengül, and B. Akarca, ISPRS Istanbul Workshop 2010 on Modeling of optical airborne and spaceborne Sensors, WG I/4, October 11-13, IAPRS Vol. XXXVIII-1/W17.

### SUMMARY OF THE INVENTION

Following is a non-exclusive list including some examples of embodiments of the invention. The invention also includes embodiments which include fewer than all the features in an example and embodiments using features from multiple examples, also if not expressly listed below.

Example 1. A method of inspecting an object of manufacture, said method comprising:
receiving:
a model of said object of manufacture, said model including one or more feature of a region of interest (ROI) of said object of manufacture; and
inspection requirements including a specification of required quality of image data of said ROI;
moving an imager with respect to said object of manufacture, while acquiring at least one image of said ROI using said imager, wherein said moving is controlled so that said at least one image provides said required quality of image data of said ROI;
extracting one or more feature of said ROI, from said at least one image; and
comparing said one or more feature of said ROI with a corresponding one or more feature of said model.

Example 2. The method according to example 1, wherein said object of manufacture comprises a plurality of ROIs; and
wherein said receiving, said moving, said extracting, and said comparing are performed for each of said plurality of ROIs.

Example 3. The method according to any one of examples 1-2, wherein said moving comprises performing Forward Motion Compensation (FMC) moving of said imager with respect to said object of manufacture.

Example 4. The method according to example 3, wherein said moving comprises moving in a first direction while performing FMC movement which comprises rotating said imager with respect to said object about a non-parallel axis to said first direction, to increase a time for which said ROI is at least partially within a FOV of said imager.

Example 5. The method according to any one of examples 1-4, comprising:
receiving one or more imaging parameter for operation of said imager;
determining one or more parameter of motion, using said one or more imaging parameter; and
wherein said moving is according to said one or more parameter of motion.

Example 6. The method according to example 5, wherein said one or more imaging parameter comprises an illumination parameter.

Example 7. The method according to example 6, wherein said imager comprises one or more illuminator, which illuminates according to said illumination parameter.

Example 8. The method according to any one of examples 1-7, comprising:
receiving one or more parameter of motion, wherein said moving is according to said one or more parameter of motion;
determining one or more imaging parameter, using said one or more parameter of motion; and
wherein said acquiring is according to said one or more imaging parameter.

Example 9. The method according to any one of examples 2-8, wherein said imager is moved along a path comprising a plurality of imaging portions, each imaging portion corresponding to an individual ROI of said plurality of ROIs and describing a path followed by said imager while acquiring said at least one image of said individual ROI.

Example 10. The method according to example 9, wherein said path comprises at least one translation portion describing a path of said imager connecting two of said plurality of imaging portions.

Example 11. The method according to example 10, wherein said imager is accelerated during said translation portion and decelerated prior to arrival at a subsequent imaging portion.

Example 12. The method according to any one of examples 10-11, wherein said two imaging portions have different directions, wherein said at least one translation portion of said path is selected to reduce acceleration of change in direction of said imager between said two imaging portions.

Example 13. The method according to any one of examples 1-12, wherein said moving comprises moving said imager.

Example 14. The method according to any one of examples 1-13, wherein said moving comprises moving said object of manufacture.

Example 15. The method according to any one of examples 1-14, wherein said extracting comprises correcting said one or more image, based on one or more parameter of said moving.

Example 16. The method according to any one of examples 5-15, wherein said one or more imaging parameter comprises one or more of illumination intensity, illumination pulse duration, illumination direction, imager shutter speed.

Example 17. The method according to any one of examples 1-16, wherein said model includes a location of said ROI on the object of manufacture.

Example 18. The method according to example 1, comprising receiving an inspection plan comprising one or more imaging parameter and/or one or more parameter of motion; wherein said imaging and said moving are according to said inspection plan.

Example 19. The method according to example 18, comprising changing said inspection plan, based on one or more of:
said one or more image;
said extracting;
said comparing; and
data received from one or more sensor.

Example 20. The method according to any one of examples 1-19, wherein said at least one image comprises a plurality of overlapping images, wherein at least a portion of said ROI is captured in one or more of said plurality of overlapping images.

Example 21. The method according to example 20, wherein at least a portion of said ROI is captured in each of said plurality overlapping images.

Example 22. The method according to any one of examples 20-21, wherein said imaging is using at least two different imaging modes.

Example 23. The method according to example 22, wherein each said imaging mode includes a plurality of imaging parameters, wherein said at least two different imaging modes have one or more different imaging parameter.

Example 24. The method according to example 23, wherein said plurality of imaging parameters include two or more of; an illumination direction, an illumination intensity, an illumination pulse duration, and an imager shutter speed.

Example 25. A method of generating an inspection plan for inspection of an object of manufacture using an imager, the method comprising:
receiving a path with time for movement of an imager, said path for imaging a ROI of said object of manufacture using said imager;
determining speed of said path with time at an imaging region of said path for said ROI;
determining distance between said path and said ROI at said imaging region;
determining Forward Motion Compensation (FMC) rotational movement of said imager at said imaging region for said ROI, using said speed and distance, said inspection plan including said path with time and said FMC movement.

Example 26. The method according to example 25, wherein said receiving is of control signals for one or more actuators configured to move said imager with respect to said object of manufacture.

Example 27. The method according to example 26, wherein said one or more actuators include actuators of a robotic arm configured to move said imager.

Example 28. The method according to any one of examples 25-26, wherein determining speed is using blur in an image of said ROI acquired while said imager moves along said imaging region portion of said path.

Example 29. The method according to any one of examples 25-28, wherein determining speed is using artificial intelligence (AI) training data wherein the AI training is to determine speed from blur within images.

Example 30. The method according to any one of examples 25-29, wherein said determining distance is using blur in an image of said ROI acquired when said imager is stationary at said imaging region portion of said path and said imager rotates at a known speed.

Example 31. The method according to any one of examples 25-30, wherein said path is for sequential imaging of a plurality of ROIs of said object of manufacture, each ROI of said plurality of ROIs having a corresponding imaging region portion of said path;
wherein said method comprises determining speed, determining distance and determining FMC rotational movement for each said imaging region.

Example 32. A method of determining an inspection plan for inspection of an object of manufacture using an imager, the method comprising:
receiving a model of said object of manufacture, said model including one or more feature of one or more ROI;
receiving inspection requirements including a specification of a required quality of image data of said one or more ROI;
generating, based on said required quality of image data, and said one or more feature of said one or more ROI, an inspection plan comprising:
movement of said imager with respect to said object of manufacture; and
one or more imaging parameter.

Example 33. The method according to example 32, wherein said receiving comprises receiving one or more given image parameter, wherein said generating is further based on said given image parameter.

Example 34. The method according to any one of examples 32-33, comprising: receiving one or more movement restriction; wherein said generating is further based on said one or more movement restriction.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such inspecting objects, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic block diagram of an inspection system, according to some embodiments of the invention

FIG. 2A is a simplified schematic showing inspection of an object by an imager, according to some embodiments in the invention;

FIG. 2B illustrates imager movement with time and collected images for stop and start imaging, according to some embodiments of the invention;

FIG. 2C illustrates imager movement with time and collected images, according to some embodiments of the invention;

FIG. 3A is a method of object inspection, according to some embodiments of the invention;

FIG. 3B is a simplified schematic block diagram showing inputs and features of an inspection plan, according to some embodiments of the invention;

FIG. 4 is a flow chart of a method of object inspection, according to some embodiments of the invention;

FIG. 5A is a simplified plot of speed of movement of an imager, with time, the imager performing movements according to an inspection plan, according to some embodiments of the invention;

FIG. 5B is a simplified schematic illustrating movements of an imager during inspection of an object, according to some embodiments of the invention;

FIG. 6 is a simplified schematic of an imaging trajectory with respect to an object to be inspected, according to some embodiments of the invention;

FIG. 7 is a flowchart of a method of inspection of an object, according to some embodiments of the invention;

FIG. 8 is a simplified schematic block diagram showing variables for generation of an inspection plan, according to some embodiments of the invention;

FIG. 9 is a flow chart of a method of determining FMC movement, according to some embodiments of the invention;

FIGS. 10-11 are simplified schematics illustrating movement of an imager during image acquisition of an object of manufacture, according to some embodiments of the invention;

FIG. 12 is a simplified schematic illustrating determining distance between an imager and a ROI, according to some embodiments of the invention;

FIG. 13 is a method of determining distance between an imager and a ROI, according to some embodiments of the invention;

FIG. 14 is a flow chart of a method of object inspection, according to some embodiments of the invention;

FIG. 15 is a flow chart of a method of system calibration, according to some embodiments of the invention; and

FIG. 16 is a simplified schematic of an inspection system, according to some embodiments of the invention.

### DESCRIPTION OF SPECIFIC EMBODIMENTS OF THE INVENTION

The present invention, in some embodiments thereof, relates to methods of and systems for inspection and, more particularly, but not exclusively, to method of and systems for optical inspection of objects.

### Overview

A broad aspect of some embodiments of the invention relates to inspection of an object of manufacture using images collected by an imager moving relative to the object, despite potential reduction of image quality associated with the movement. A potential advantage of moving the imager is increased speed of inspection of the object.

Generally, during robotic inspection of manufactured objects, movement and imaging parameters are controlled to provide the best quality image for accurate inspection. The inventors, however, have realized that this is not necessary, that inspection time is potentially decreased by employing movements of the imager with minimal penalty in terms of acquired image data of regions of interest.

In some embodiments the imager is moved with respect to the object. In some embodiments, additionally or alternatively, the object is moved with respect to the imager. When movement of the imager or object is described in this application, it should be understood, that, in some embodiments, this movement is relative movement between the imager and the object effected by movement of one or both of the imager and object.

In some embodiments, the imager is an area scan camera which collects images using an array of sensor pixels. In some embodiments, the imager is moved relative to the inspected object by a robotic system, for example, a robotic system having a robotic arm which moves the imager. Additionally or alternatively, in some embodiments, the object is moved relative to the imager.

In some embodiments the object of manufacture includes a plurality of regions of interest (ROIs) each of which are imaged in the inspection, wherein the imager moves between ROIs to collect image/s of each ROI. In some embodiments, inspection of the object involves acquiring a certain amount of image data of each ROI. In some embodiments, instead of moving between ROIs and pausing movement at each ROI for image acquisition, the imager continues to move whilst acquiring image/s of the ROI.

In some embodiments, continuing to move the imager while collecting image/s of an ROI (e.g. as opposed to stopping the imager at a vicinity of an ROI to image it) reduces acceleration and/or deceleration experienced by the imager. Excessive acceleration/deceleration potentially reduces image quality of images collected by the imager, e.g. due to vibration/s generated which potentially reduce image quality. In some embodiments, reduction of accelerations experienced by the imager reduces stabilization time required (e.g. associated with vibrations) before the imager is able to collect sufficiently high quality images for object inspection. Potentially, reduction and/or lack of stabilization time for the imager increases inspection speed.

Potentially, reduction in inspection time is more significant for objects having many ROI's and/or from which images are to be collected from a spatial region much larger than a single imager FOV (e.g. 2-100 times the imager FOV, in at least one direction).

An aspect of some embodiments of the invention relates to collecting image/s of an ROI while translating the imager past a ROI while concurrently performing Forward Motion Compensation (FMC) on the imager.

In some embodiments, FMC includes rotating the imager around a rotation axis which is at an angle to a direction of translational movement of the imager. In some embodiments, effective rotation of the imager around the rotation axis is effected by mechanical rotational movement around one or more axes. In an exemplary embodiment, rotation is about an axis which passes through an entrance pupil of the imager (e.g. a center of the entrance pupil). A potential benefit being reduction of parallax effects of out of plane features. Alternatively, in some embodiments, the rotation is about one or more mechanically convenient locations e.g. mechanically convenient for the imager and/or device/s (e.g. a robotic arm) configured for movement of the imager.

In some embodiments, imager concurrent translational movement and rotation are effected by a robotic inspection system.

Alternatively or additionally, in some embodiments, FMC includes acquiring images (using the translating imager) via a rotating mirror capturing the ROI. The mirror rotation is arranged to at least partially offset ROI shift (due to the translation of the imager).

Alternatively or additionally, in some embodiments, FMC includes laterally shifting one or more components within a translating imager, e.g. shifting a lens element and/or shifting the imager sensor during exposure.

Potentially, FMC reduces degradation in image quality caused by the translational movement. FMC, potentially, in some embodiments, reducing blur in acquired images. For example, a potential advantage of FMC is improved signal to noise ratio (SNR) and/or dynamic range of acquired images e.g. for a given amount of residual blur. In some embodiments, FMC movement reduces blur over substantially the entire field of the collected image/s.

In some embodiments, FMC movement improves image quality (e.g. from that which would be seen in an image collected without the FMC rotational movement), for example reduces blur, to different extents in different regions of collected image/s. In some embodiments, a ROI is captured in a region of the collected image/s which exhibits higher improvements in image quality e.g. less blur.

In some embodiments, the FMC movement enables longer image acquisition times; for example, increased shutter time (also herein termed “exposure time”) and/or (when active illumination, e.g. non-ambient illumination, is used), increased illumination pulse time. For example, in an exemplary embodiment, an illumination pulse time is used which is longer than that which produces blur free images, without FMC movement, for the same speed of translational movement. Additionally or alternatively, in some embodiments, the FMC movement enables faster movement of the imager while imaging.

A potential benefit of the FMC movement is the ability to inspect objects with poor object reflectance and/or to collect images using limited illumination intensity.

Potentially, FMC movement enables rapid inspection of dimly lit objects, using low power lighting.

In some embodiments, during inspection of an ROI, a single image is collected.

In some embodiments, during movement of the imager past an ROI, a plurality of images including the ROI are collected. In some embodiments, the images include overlapping portions of the ROI potentially enabling data combination of the images for inspection of the ROI.

In some embodiments, a plurality of images collected of a large ROI (the ROI is larger than the FOV of the imager) combining of the plurality of images enabling inspection of the ROI.

In some embodiments, combination of acquired images enables acquisition of images of an ROI under different illuminations (and/or using different imaging parameter/s) and/or inspection of ROIs wherein the ROI is larger than the FOV of the imager (in some embodiments, the size of the imager FOV with respect to the ROI being dependent on imager feature/s and/or distance between the imager and the ROI).

In some embodiments, multiple images are collected of an ROI during movement of the imager past the ROI when more than one imaging mode (e.g. imaging modes having one or more different illumination parameters and/or imaging parameters) is used. In some embodiments, the ROI is allowed to move within the FOV between image acquisitions (e.g. FMC movement is reduced e.g. momentarily, to a level where at the ROI is allowed to shift within the FOV of the imager). In some embodiments, the acquired images are at least partially overlapping. The at least partial overlap may be determined, for example, insofar as the images are co-registered (e.g. using known movement of the ROI within the imager FOV between image acquisitions) during processing. A plurality of images of a single feature optionally comprises images of an object feature under different imaging modes, e.g. under different illuminations. The differences may assist in emphasizing (e.g., by differential shadowing) different surfaces, surface flaws, and/or 3-D positioning of the object feature. The known movement of the ROI within the image is determined, for example, using known speed of translational and/or rotational movement of the imager.

In some embodiments, the images are overlapping. In some embodiments, the same portions of the ROI are captured using different imaging modes (e.g. having different illumination parameter/s and/or other different imaging parameter/s) potentially providing additional data for inspection of the ROI. For example, in some embodiments, images acquired under different illuminations are combined to provide an image of the ROI with increased defect contrast. For example, in some embodiments, images acquired under different exposure levels are combined to provide an image of the ROI with increased dynamic range.

In an exemplary embodiment, the imager is moved by a robotic arm. For example, the imager is mounted to the robotic arm. In some embodiments, an illumination assembly is also moved by the robotic arm (e.g. the illumination assembly is mounted to the robotic arm).

An aspect of some embodiments of the invention relates to generating an inspection plan for optimized inspection of an object of manufacture. In some embodiments, the inspection plan includes movement of the imager with time and/or image collection parameter/s with time.

In some embodiments, all features of an inspection plan are determined together. For example, an inspection plan is generated by optimizing movement and/or imaging parameters (e.g. for one or more variables; for example, optimized for a minimum time inspection plan) using inputs including a model of the object to be inspected and limits to variables e.g. movement and/or imaging parameters.

In some embodiments, generation of an inspection plan includes more than one sequential stage.

For example, in some embodiments, one or more variables for a movement trajectory are selected, and one or more other variables are determined based on the selected variable/s. The determining, in some embodiments, is part of generating an inspection plan e.g. by optimizing one or more portions of the inspection plan.

For example, in some embodiments, an order of ROI to be inspected is determined e.g. prior to determining detailed movement and/or imaging parameters. In some embodiments, non-imaging portions of an inspection plan and imaging portions are determined e.g. prior to determining detailed movement and/or imaging parameters. In some embodiments, the portions are determined based on division of an inspection plan trajectory into imaging and non-imaging portions.

In some embodiments, one or more portions of an inspection plan is set. For example, in some embodiments, imaging parameter/s are determined by object properties e.g. reflectance.

In an exemplary embodiment, translational movement of the inspection plan is determined and then FMC motion is calculated based on given translational movement, distance between the object and the imager, and given imaging parameters.

In some embodiments, translational movement of an inspection plan is determined and/or modified for example, independent of and/or prior to determining the FMC motion.

In some embodiments, a shortest distance path connecting imager positions for imaging a plurality of ROIs (e.g. a motion comprising discrete sections) has angular turns. The path is optionally smoothed, potentially reducing accelerations and/or enabling higher continuous movement speeds. In some embodiments, smoothing of the path is performed by adding imager positions along the path additional to those defined by imaging requirements.

In some embodiments the imager translational movement is slowed while acquiring images. In some embodiments the imager is accelerated to a higher speed while moving between ROI regions.

In some embodiments, images are acquired using a robotic system comprising actuator/s which move the imager with respect to the object to be inspected.

An aspect of some embodiments of the invention relates to using acquired images to calibrate movement and/or position of an imager e.g. during movements of an inspection plan. In some embodiments, FMC movement is determined, for an inspection plan, using the calibration.

In some embodiments, a partial inspection plan (e.g. for a specific object) including, for example, a path (e.g. with time) of the imager, is calibrated using images acquired by the imager. For example, speed of movement of the imager is determined and/or distance between the imager and the object to be inspected is determined from acquired images, for one or more portions of the path. The one or more portions include, for example, imaging acquisition regions of the path.

In some embodiments, using acquired images to calibrate the partial inspection plan potentially improves accuracy of knowledge of position and/or speed of the imager. For example, increased accuracy of knowledge of speed over that provided by control signals e.g. for actuator/s moving the imager. For example, increased accuracy of knowledge of distance between the object ROI and the imager, over knowledge provided by imager focusing on the ROI. For example, when the imager is focused to a given distance, the finite depth of focus of the imager, allows that distance to vary.

A potential benefit of calibration using acquired images is the potential ability to determine speed of movement of the imager and/or distance between the imager and the object to be inspected at a higher accuracy that available using actuator control signals for movement of the imager and/or using imager magnification calibration. Potentially, the higher accuracy is used to increase improvements of image quality using FMC movements.

A particular benefit being to those systems for which movements of the imager with respect to the object are repeatable (e.g. for successive objects of the same type), and, optionally, in some embodiments, not known sufficiently accurately for determining of FMC to improve image quality of images acquired while moving the imager. Given a sufficient repeatability of imager movements: in some embodiments, calibration is performed on an object of a type, and the calibration (e.g. calibrated inspection plan) is then used for inspection of successive objects of the same type. In some embodiments, successive objects are inspected by other systems of the same type as that for which calibration was performed. In some embodiments, the same inspection plan using calibration parameters e.g. translation speed and/or imager distance obtained on one system, are used on other inspection systems of the same type inspecting objects of the same type.

In some embodiments, the partial inspection plan is generated to produce image data of one or more ROIs of the object to be inspected under imaging conditions resulting in the image data being degraded to a level insufficient for inspection of the ROI. Relevant imaging conditions include, for example, one or more of illumination power, illumination pulse duration, shutter speed, imaging lens aperture, imaging focus setting, distance between the object of manufacture and imager, and speed of movement of the imager during image acquisition.

In some embodiments, motion of the imager (e.g. robotic motion of the imager) is repeatable but the speed and/or distance between the imager and the object of manufacture are not known sufficiently accurately e.g. to determine FMC movement e.g. for collection of sufficiently blur-free images.

In some embodiments, imager movement actuator commands result in movements which are repeatable but the commands are not accurately calibrated to the movements.

In some embodiments, for example, to provide sufficiently blur-free images, FMC is determined once imager movements have already been prescribed e.g. in an inspection plan and/or in a step-wise generation of an inspection plan.

In an exemplary embodiment, imager speed of movement and/or distance between the imager and the ROI for one or more image acquisition regions of the imager trajectory are determined.

In some embodiments, the distance and/or imager speed are determined using image blur in acquired images e.g. during calibration for inspection plan generation.

In some embodiments, angular speed for FMC movement is determined using:

$$ω = \frac{v}{h} \qquad Equation 1$$

Where ω is the angular FMC speed in radians/s needed for blur elimination, v is the relative translational speed between imager and object, and h is the distance between the imager and the ROI. In some embodiments, h is taken as the distance between the location of the imager rotation axis and the imaged ROI.

Equation 1, provided in “MECHANICAL FMC TECHNIQUES FOR REMOVING IMAGE BLUR IN DIGITAL AERIAL CAMERAS” by O. Selimoglu, O. Yilmaz, O. Şengül, and B. Akarca, ISPRS Istanbul Workshop 2010 on Modeling of optical airborne and spaceborne Sensors, WG I/4, October 11-13, IAPRS Vol. XXXVIII-1/W17.

In some embodiments, an artificial intelligence (AI) system (e.g., separately trained), is used to determine speed and/or distance from the image blur. Potentially training the AI system separately increases speed of determining the FMC rotation and/or reduces computation load in determining the FMC rotation e.g. for inspection of a particular object.

In some embodiments, applying a desired amount of FMC rotation during translation movement past an ROI involves accelerating rotational movement of the imager to the desired angular speed. In some embodiments, to then inspect an additional ROI, rotation of the imager is then decelerated and/or realigned angularly before being reaccelerated to the desired angular speed for imaging of the additional ROI. In some embodiments, imaging of the additional ROI involves a different angular movement during imaging.

In some embodiments, linear translation of the imager is at a speed which is lower than a maximum speed, for example, when the imager is moving over regions of space in which it acquires images, to enable the angular orientation and/or speed to change sufficiently slowly (e.g. to avoid vibrations) during image acquisition.

In some embodiments, generation of an inspection plan includes one or more features as illustrated and/or described in U.S. Pat. No. 10,916,005 and/or in U.S. Patent Publication No. 2021/0082105; both of which are assigned to the same assignee as the present invention and are hereby incorporated by reference in their entirety.

An aspect of some embodiments of the invention relates to generating an inspection plan for an object of manufacture using a first processor. The first processor generates an optimized inspection plan by varying a plurality of variables to provide one or more optimized variables. For example, in some embodiments, imager speed of movement, both translational and rotational are varied to provide optimized inspection speed. In some embodiments, the generated inspection plan is then delivered (or retrieved by) a processor local to an inspection system. A potential advantage being the ability to perform computationally heavy optimization for inspection plans off site and/or potentially enabling local inspection systems to have lower computational requirements.

A benefit of some embodiments of the invention is the ability to efficiently inspect complex objects of manufacture. For example, the object has a ROI on more than one side of the object, has ROIs at different angle/s, and/or has an irregular shape.

In some embodiments, the object is an object of manufacture, also herein termed “workpiece”. In some embodiments, relative speed of movement between the imager and object is at a speed of 50-700 mm/s, or 100-500 mm/s, or lower or higher or intermediate ranges or speeds. In some embodiments, distance between the imager and the ROI is 100-700 mm, or 200-500 mm, or lower or higher or intermediate ranges or distances. In some embodiments, imager exposure time is 0.5-15 ms, or 1-10 ms, or lower or higher or intermediate ranges or durations. In some embodiments, (e.g. under speed and/or distance and/or exposure time stated previously) the distance travelled during exposure is 0.1-5 mm, and/or the corresponding FMC rotation during exposure is 0.01-3 degrees e.g. for each single exposure. In some embodiments, wherein acquisition uses a plurality of imaging modes (e.g. as described elsewhere in this document) distance traveled and/or FMC angles are a multiple (e.g. the multiple corresponding to the number of imaging modes) of the single exposure values.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary System

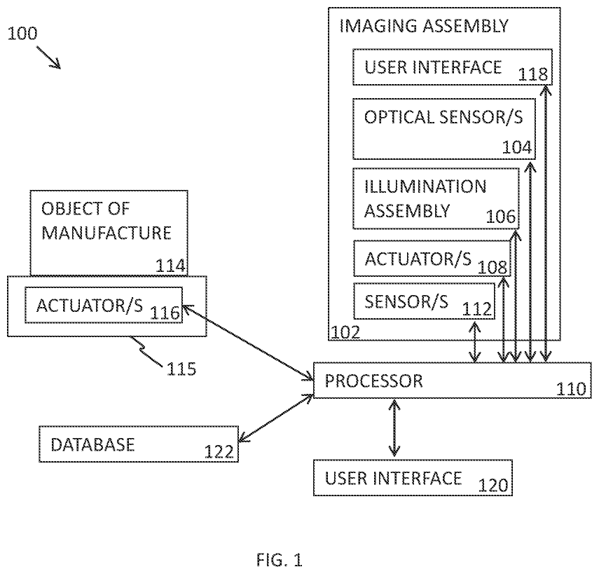

FIG. 1 is a simplified schematic block diagram of an inspection system 100, according to some embodiments of the invention.

In some embodiments, inspection system 100 is configured to inspect an inspection object 114. For example, by collecting optical data regarding (e.g. image/s of) one or more ROIs of inspection object 114.

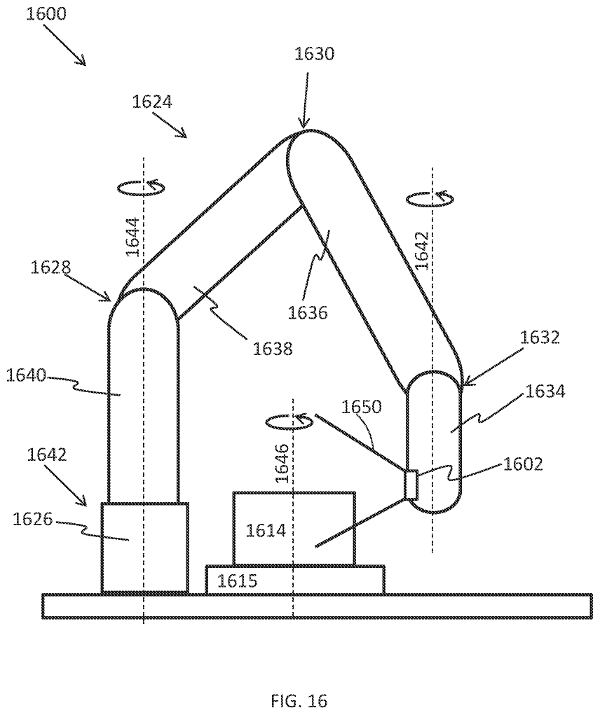

In some embodiments, system 100 includes an imaging assembly 102. In some embodiments, imaging assembly 102 includes a robotic arm (e.g. including one or more features as illustrated in and/or described regarding arm 1624 FIG. 16).

In some embodiments, imaging assembly 102 includes one or more optical sensors 104, for example, including one or more cameras e.g. one or more area scan cameras. In some embodiments optical sensor/s 104 are moved by one or more actuators 108 (e.g. actuators of a robotic arm). In some embodiments, imaging assembly 102 includes an illumination assembly 106 including, for example, one or more light sources. In some embodiments, illumination assembly 106 is moved with optical sensor/s 104 e.g. by actuator/s 108.

Optionally, in some embodiments, imaging assembly 102 includes a user interface 118 e.g. configured to receive inputs from a user and/or communicate information to a user. User interface 118 including, for example, one or more input devices and/or output device e.g. one or more buttons, switches, screens, lights, speakers, and/or microphones.

Optionally, in some embodiments, imaging assembly 102 includes one or more sensors 112. For example, sensor/s 112 include one or more sensors configured to sense movement of one or more portions of imaging assembly 102 e.g. movement of optical sensor/s 104 e.g. one or more gyroscopes, accelerometers, and/or encoders (e.g. electrical encoders such as an optical encoder). In some embodiments, sensor/s 112 include one or more proximity sensors. In some embodiments, sensor/s include user input sensor/s e.g. touch sensor/s.

In some embodiments, system 100 includes one or more user interfaces 120 which receive input/s from a user and/or outputs information to the user.

In some embodiments, a processor 110 controls of one or more portions of imaging assembly 102 e.g. sending control signal/s and/or receiving data from the portion/s. For example, in some embodiments, processor 110 sends movement control signals to actuator/s 108 and/or sends imaging control signals to optical sensor/s 104, and/or sends lighting control signals to illumination assembly 106 and/or sends outputs for display to a user at user interface 120. For example, in some embodiments, processor 110 receives acquired image data from optical sensor/s 104 and/or user input/s from user interface 120. In some embodiments, processor 110 is hosted externally to the imaging assembly. Alternatively or additionally, in some embodiments, imaging assembly 102 includes a processor.

In some embodiments, system 100 includes one or more databases 122. In some embodiments, database 122 is external to imaging assembly 102. Additionally or alternatively, in some embodiments, database 122 is hosted externally to imaging assembly 102. In some embodiments, database stores inspection plan/s and/or inspection protocols and/or object model/s and/or is used to store movement and/or image data.

In some embodiments, system 100 includes one or more actuators 116 configured to move inspection object 114 (e.g. with respect to imaging assembly 102). In some embodiments, actuator/s 116 receive control signals from processor 110. In some embodiments, actuators 116 move a holder and/or support 115 for the object of manufacture 114 e.g. do not directly move the object of manufacture.

### Exemplary Method of Object Inspection

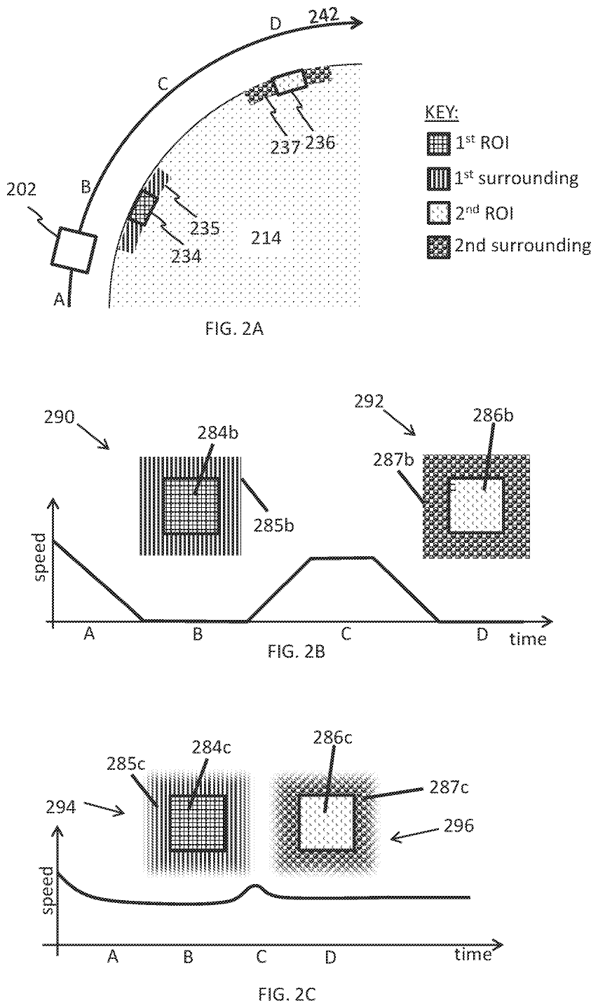

FIG. 2A is a simplified schematic showing inspection of an object 214 by an imager 202, according to some embodiments of the invention.

In some embodiments, arrow 242 illustrates a trajectory of imager 202 from region A, through regions B, C and D. Regions A and C are transition trajectories leading to regions B and D respectively, with image/s being collected of a first ROI 234 and a second ROI 236 respectively. In some embodiments, first ROI 234 is surrounded by a first object region 235 and second ROI 236 is surrounded by a second object region 237.

FIG. 2B illustrates imager movement with time and collected images 290, 292 for stop and start imaging, according to some implementations of the invention.

FIG. 2C illustrates imager movement with time and collected images, according to some embodiments of the invention.

In FIG. 2B the imager stops at regions B and D to collect images 290, 292 respectively, using a static imager and the resulting ROI portions 284b, 286b of the images and surrounding object regions 285b, 287b are of similar image quality.

In some embodiments, for the inspection illustrated in FIG. 2B, the time taken to perform the inspection is longer than that illustrated in FIG. 2C. For example, the duration increased by the stop time at imaging regions and/or acceleration and deceleration times at regions A and C between imaging regions B and D.

In FIG. 2C, the imager continues to move while collecting images. The collected images 294, 296, in some embodiments, have degraded quality, for example, in regions surrounding the ROIs 285c, 287c. In some embodiments the inspection illustrated in FIG. 2C has a shorter duration than that illustrated in FIG. 2B while still collecting required image data of the ROIs 284c, 286c.

### Exemplary Inspection Plan/s

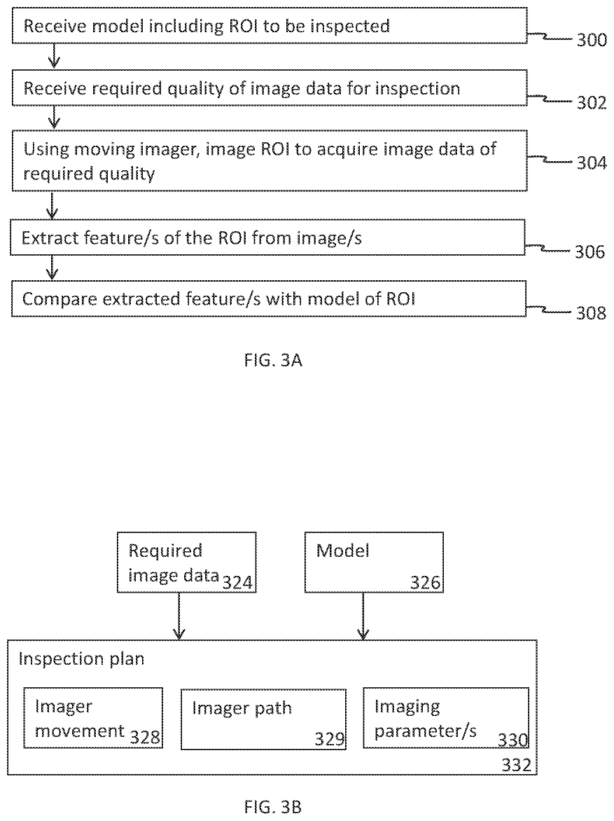

FIG. 3A is a method of object inspection, according to some embodiments of the invention.

At 300, in some embodiments, a model of an object to be inspected is received. In some embodiments, the model includes one or more features of one or more ROIs of the object.

At 302, in some embodiments, required quality of image data for inspection of the ROI/s is received. In some embodiments, required image quality is expressed in terms of objective imaging parameters such as one or more of SNR, dynamic range, and image sharpness e.g. modulation transfer function (MTF) values.

At 304, in some embodiments, the imager moves and acquires images according to an inspection plan. In some embodiments, while the imager is moving, image/s are acquired of the one or more ROIs. In some embodiments, movement of the imager and imaging parameter/s are together configured for acquisition of the required quality of image data. In some embodiments, sufficient data for an ROI is collected in a single pass of the imager past the ROI. For example, the imager movement while acquiring image/s includes translational and/or rotational movement; and in an exemplary embodiment, uses both movements concurrently, for at least a portion of the inspection duration.

At 306, in some embodiments, for each ROI, one or more features of the ROI are extracted from the collected images. In some embodiments, prior to extraction, noise and/or distortion is removed from images and/or corrected for. Alternatively or additionally, in some embodiments, extraction uses selected portion/s of the image (e.g. distortion and/or blur-free portion/s).

At 308, in some embodiments, extracted features are compared with corresponding features of the model received at step 300. In some embodiments, result/s of the comparison are outputted (e.g. to a user interface) and/or saved in a memory.

Optionally, in some embodiments, based on the comparison, further inspection is carried out. Reasons for this may include, for example, that the initial comparison is inconclusive as to whether the object passes the inspection, and/or to double check when the comparison indicates that the object has failed to fulfil inspection requirement/s.

FIG. 3B is a simplified schematic block diagram showing inputs 324, 326 and features 328, 329, 330 of an inspection plan 332, according to some embodiments of the invention.

In some embodiments, one or more of features 328, 329, are varied to generate an inspection plan e.g. an optimized inspection plan.

In some embodiments, inspection e.g. of an object of manufacture, includes controlling an imager according to inspection plan 332.

In some embodiments, inspection plan 332 includes, for one or more imagers (e.g. including an imager configured to be moved by a robotic arm), imager movement 328, an imager path 329, and one or more imaging parameters 330.

Imager movement 328, includes, in some embodiments, speeds of imager translation and rotational movement during the inspection. Imager path 329 includes, for example, position of the imager e.g. with respect the object of manufacture. Imager path 329, in some embodiments, includes an order of ROIs of the object which are imaged.

Imaging parameter/s 330, in some embodiments, include one or more image acquisition parameters and/or one or more illumination parameters when, during path 329, image/s are collected. Image acquisition parameter/s include, for example, one or more of shutter speed, aperture, and focus setting for images collected. For example, illumination parameter/s include illumination pulse strength, duration, and/or which illuminators are activated (when there is more than one).

In some embodiments, imaging parameter/s 330 include whether a single or plurality of images are collected of a ROI e.g. during translational movement past the ROI. And, in some embodiments, under what conditions a plurality of images of the ROI are collected e.g. in some embodiments, different images of a single ROI are acquired under different shutter speeds and/or illumination and/or with different overlaps in the images.

In some embodiments, the inspection plan is generated and/or is based on one or more inputs 324, 326.

In some embodiments, input/s include a model 326 of the object to be inspected. In some embodiments, model 326 includes feature/s of one or more ROIs of the object.

In some embodiments, input/s include required image data 324 for inspection of the object of interest e.g. for one or more ROIs.

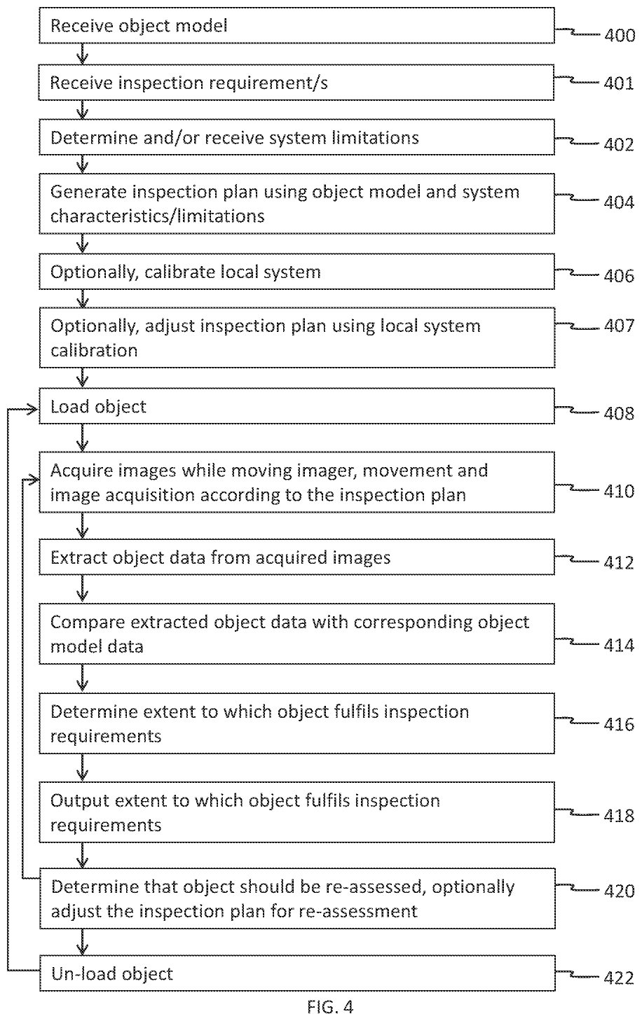

FIG. 4 is a flow chart of a method of object inspection, according to some embodiments of the invention.

At 400, in some embodiments, an object model is received. In some embodiments, the model includes one or more features of the object to be inspected. For example, external geometry and/or geometry. In some embodiments, the model includes feature/s of one or more ROIs of the object. For example, position of the ROI on the object. For example, size and/or shape and/or appearance of the ROI and/or of portion/s of the ROI.

At 401, in some embodiments, one or more inspection requirements are received, including one or more features of data to be acquired for inspection of the object.

At 402, in some embodiments, system limitation/s are determined and/or received.

In some embodiments, system limitations include potential positions within space of an imager of the system. The positions, for example, as defined and/or limited by freedom of movement of a robotic arm which moves the imager e.g. freedom of movement at each joint of the robotic arm. Additionally or alternatively, the positions, as defined and/or limited by borders of the space in which the imager is moved, for example, walls and/or other objects which prevent movement and/or for which collision with is to be avoided.

In some embodiments, system limitations include speed and/or acceleration of movement of the imager, for example, as limited by the actuators moving the imager and/or by the weight of the imager and/or other portions of the system moved with the imager (e.g. illumination assembly). In some embodiments, speed and/or acceleration of movement of the imager is limited by the effect of such parameters on image quality of images acquired with the imager.

In some embodiments, specification of one or more system limitations is received, for example, from a database in which they are stored. Alternatively or additionally, in some embodiments, one or more system limitations is measured. Measurements are used, in some embodiments, to define the limitation/s and/or adjust received limitations.

At 404, in some embodiments, an object inspection plan is generated, for example, using one or more of (e.g. all of) the object model, inspection requirement/s, and system limitations.

In some embodiments, the inspection plan includes an order of ROIs to be inspected.

In some embodiments, generation of the inspection plan is performed. For example, within their established limitations (e.g. established via received data at step 400 and/or step 402) variables of the inspection plan are varied together and adjusted (e.g., incrementally) to provide an inspection plan optimized for one or more features e.g. optimized for minimum time.

Alternatively, generation of the inspection plan is sequential. For example, a first portion is generated followed by one or more subsequent portions. In some embodiments, generation of one or more portions includes varying one or more variables and/or optimizing for one or more variables.

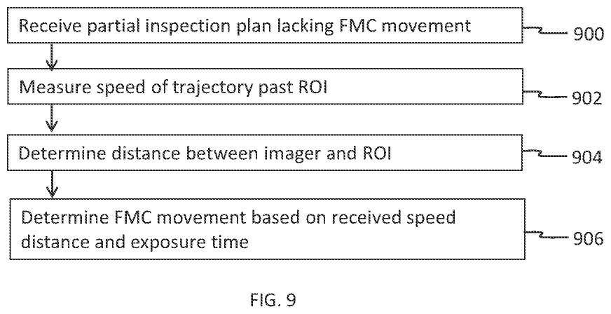

For example, in some embodiments, an order of inspection of ROIs is first determined. From this order, movement trajectories (e.g. as described regarding FIG. 8) are determined, and then optimized. In an exemplary embodiment, translational movement is first determined, based on a set exposure time and then rotational movement of the imager (FMC movement) is determined based on the translational movement parameter/s and the exposure time. For example, as described in and/or regarding FIG. 9.

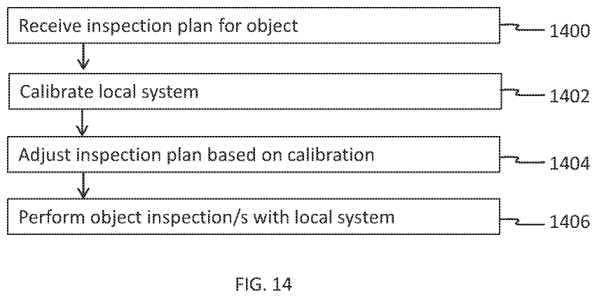

At 406, optionally, in some embodiments, a local system is calibrated. For example, according to one or more features as illustrated in and/or described regarding FIG. 14.

At 407, in some embodiments, the inspection plan is adjusted, based on the local system calibration.

At 408, in some embodiments, an object to be inspected is loaded to the system. For example, placed on a support e.g. support 115 FIG. 1. For example, moved into an inspection zone e.g. by a conveyor belt.

At 410, in some embodiments, images are acquired while moving the imager with respect to the object of inspection and according to the inspection plan.

In some embodiments, one image is acquired for each ROI of the object.

In some embodiments, more than one image is acquired for one or more ROIs, e.g. for each ROI.

In some embodiments, the ROI is allowed to move within the FOV for multiple images of the ROI. In some embodiments, the images include overlapping portions of the FOV. In some embodiments, overlap between the images is used for co-registering and then combining of the images during image processing.

In some embodiments, FMC movement is performed during acquisition of one or more of the plurality of images of an ROI.

In some embodiments, a single FMC movement is performed during multiple acquisitions wherein the FMC movement is sufficient to provide overlapping portions of the ROIs, but allows the ROI to move within the FOV.

In some embodiments, the imager performs a plurality of FMC movements for a single ROI. For example, in some embodiments, a first portion of an ROI is acquired while performing a first FMC movement and a second portion of the same ROI (e.g. the first and second portions being overlapping) is acquired while performing a second FMC movement.

In some embodiments, the first FMC movement includes rotating the imager from angle A to B, and prior to the second acquisition the imager rotation is returned to angle A (or towards angle A). The second FMC movement includes rotating the imager a second time e.g. in the direction of angle A to B. A potential advantage of performing separate FMC movements for multiple images is reduced total angle of FMC rotation, potentially reducing imaging distortion.

In some embodiments, a plurality of images are acquired of a single ROI. The ROI is maintained in a same portion of the different images e.g. by FMC movement. In some embodiments, the images are acquired using different imaging conditions (e.g. different imaging modes including different illumination parameter/s).

In some embodiments, images are acquired of an ROI, using different imaging conditions, the ROI being allowed to move within the FOV of the imager. In some embodiments, a plurality of overlapping images of the ROI are acquired under different imaging conditions. For example, using different acquisition time and/or illumination power.

For example, in some embodiments, a first image is acquired using a first exposure time and a second image is acquired using a second exposure time shorter than the first exposure time. Potentially, the longer exposure time image has increased quality for portion/s of the ROI with low lighting and/or reflectance. Potentially, the shorter exposure time image has increased quality for portion/s with high lighting and/or reflection e.g. which in some embodiments, saturate image/s with longer exposure time. Variation/s in lighting, in some embodiments, being associated with varying distance from illuminator/s and/or whether the region in question is shaded from one or more illuminators.

In some embodiments, when more than one image of an ROI is collected using different imaging modes, minimal overlap of the ROI in the images is related to the number of imaging modes.

For example, in an exemplary embodiment, for each portion of an ROI to be acquired under each illumination mode, the illumination mode is changed between acquired images and the imager moves during imaging. The overlap percentage between images is larger than

$$( 1 - \frac{1}{n} ) \cdot 100 \% ,$$

where n is the number of imaging modes. For example, in some embodiments, for two imaging modes, any two images will overlap by at least 50%. For example, in some embodiments, for three imaging modes, any two images will overlap by at least 67%, for 4 modes overlap is by at least 75%. In an exemplary embodiment, different imaging modes differ by illumination parameter/s.

A potential advantage of acquiring a plurality of images of a single ROI (e.g. under different imaging modes) is the ability to have more FMC movements e.g. up to an FMC movement for each individual image acquisition. For example, in some embodiments, while following a movement path past an ROI, the imager acquires a first image while rotating from rotational angle A to angle B, and then resets the angle of the imager to angle A prior to acquire the second image of the ROI (e.g. which overlaps the first), optionally, under a different illumination mode. In some embodiments, the imager partially resets the FMC rotational angle, for example, returning to an angle in between angles A and B prior to acquiring the second image of the ROI. In some embodiments, this results in FMC motions having shorter angular stroke e.g. as opposed to multiple images acquired during one longer stroke. This potentially results in improved image quality. In some embodiments, the separate images are then co-registered computationally. With a single longer stroke, in some embodiments, the multiple images are optically maintained in registration.

Acquiring multiple overlapping images, in some embodiments, includes one or more features as described and/or illustrated in U.S. Pat. No. 8,119,969 e.g. FIGS. 1B-C, which patent publication is herein incorporated by reference in its entirely.

At 412, in some embodiments, data is extracted from the acquired images.

For example, in some embodiments, overlapping images (e.g. acquired using different imaging modes) are registered to each other (e.g. the overlapping images are “co-registered”).

In some embodiments, co-registering is based on one or more of known imager speed, rotation angle, optical magnification and elapsed time interval between image acquisitions. Alternatively or additionally, co-registering is by using matching image features within the overlapping zones of the registered images (in some embodiments, the matching features are first identified).

At 414, in some embodiments, data extracted from the acquired images is compared to corresponding data from the object model.

At 416, in some embodiments, based on the comparison performed at step 414 an extent to which the object fulfils inspection requirements is determined. In some embodiments, an inspection score for the object is determined. In some embodiments, a score is generated for each ROI and/or for groups of ROIs. For example, in some embodiments, one or more ROI has a multi-parameter score.

At 418, in some embodiments, the inspection score is outputted. For example, to a memory and/or user interface. Optionally, in some embodiments, images of ROI's containing suspected defects (e.g. with inspection score/s which indicate defects) are sent to a user interface e.g. a device configured to display information to a user.

At 420, in some embodiments, based on one or more portions of the inspection score, it is determined that the object should be re-assessed. Optionally, the inspection plan is adjusted for the re-assessment e.g. to inspect only those ROIs with borderline scores. In some embodiments, steps 410-418 are performed again, optionally according to the adjusted inspection plan.

At 422, in some embodiments, the object is un-loaded from the inspection system. For example, by removing the object from the support. For example, by movement of the support (e.g. the object is moved away from the inspection zone e.g. by a conveyor belt).

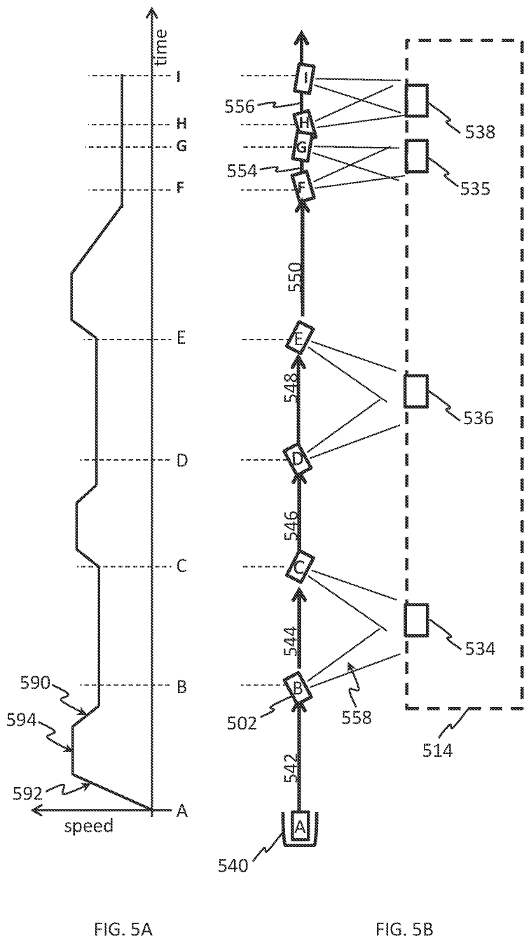

FIG. 5A is a simplified plot of speed of movement of an imager, with time, the imager performing movements according to an inspection plan, according to some embodiments of the invention.

FIG. 5B is a simplified schematic illustrating movements of an imager 502 during inspection of an object 514, according to some embodiments of the invention.

In some embodiments, FIG. 5A and FIG. 5B are aligned so that speed illustrated in FIG. 5A with time is associated with same position of the imager along the imaging trajectory illustrated in FIG. 5B. The imaging trajectory illustrated in FIG. 5B, in some embodiments, includes a plurality of trajectory portions 542, 544, 546, 548, 550, 554, 556.

In some embodiments, imager 502 moves sequentially between positions denoted by the letters A-I.

The object 514, in some embodiments, has a first ROI 534 and a second ROI 536. In some embodiments, during movement of imager 502 along trajectories 542, 544, 546, 548 and between illustrated positions A-E the imager performs translational movement and optionally rotational movement (e.g. as illustrated in FIG. 5B) of imager 502.

In some embodiments, trajectory portions are either translational trajectories 542, 546 or imaging trajectories 544, 546 with one or more ROI within a FOV 558 of imager 502. In some embodiments, during imaging trajectories, image/s are collected. During translational trajectories 542, 546, in some embodiments, the imager is prepared for collection of images, but, in some embodiments, images are not collected.

In FIG. 5A, imaging trajectories 544, 548, 550, 554, 556 are similar to and/or longer in time duration than translational trajectories 542, 546, 550. However, in an exemplary embodiment, duration of image acquisition is less than that of translational trajectories. For example, imaging trajectories for an inspection having less than half, or less than 20%, or less than 10%, or less than 5%, a duration of the translational trajectories.

In some embodiments, at position A, imager 504 is within a home position e.g. within a dock 540. In some embodiments, between position A and position B, for example along trajectory 542, imager 502 is prepared for imaging. Between positions B and C (e.g. while moving along trajectory 544) imager 502 acquires one or more images of ROI 534. During preparing (e.g. between position A and position B), in some embodiments, the imager is accelerated or decelerated to a desired speed for collecting images. Additionally or alternatively, in some embodiments, preparation includes changing an angular orientation of the camera e.g. from the angular orientation at docking to that of position B. In some embodiments, for example, as illustrated in FIG. 5A, it is during a final portion of trajectory 542 that the speed of imager 502 is prepared for imaging which occurs between B and C. The speed of imager 502 is reduced during a final portion 590 of the trajectory between A and B e.g. to reduce the imager angular rotation rate requirements and/or to allow more time for image acquisition between B and C. In some embodiments, potentially reducing overall time required for the inspection, the imager is initially accelerated 592 to a higher speed 594 (e.g. maximum speed).

In some embodiments, during trajectory 544 between positions B and C imager 502 moves linearly along trajectory 544 while concurrently rotating to change the angular orientation of imager 502 with respect to first FOV 534 and acquiring image/s. Illustrated rotation angles are larger than occur in some embodiments, Rotation being, in an exemplary embodiment, of, for example, 0.5-30°, or 0.5-10°, or 0.1-5°, or lower or higher or intermediate ranges or angles.

In some embodiments, between position C and D, e.g. while moving along trajectory 546, imager 502 is prepared for imaging. For example, the imager rotates from the angular orientation illustrated at position C to that illustrated at position D. In some embodiments, the imager speed is also prepared for imaging which occurs between D and E e.g. as described regarding preparation of speed of the imager during trajectory 542. For example, as illustrated in FIG. 5A, in some embodiments, at position C, the imager accelerates linearly before decelerating to a speed suitable for imaging between positions D and E.

In some embodiments, during trajectory 548 between positions D and E imager 502 moves linearly along trajectory 548 while concurrently rotating to change the angular orientation of imager 502 with respect to second FOV 536 and acquiring image/s.

In some embodiments, object 514 includes a third 535 and a fourth 538 ROI which are closer together on object 514 than the first and second ROIs 534, 536.

In some embodiments, third 535 and fourth 538 ROI that are contiguous, e.g. forming part of an extended ROI. In some embodiments, continuous and/or closely spaced ROIs are partially overlapping at their edges potentially preventing uninspected zones.

In some embodiments, to reduce acceleration associated with back and forth angular rotation of the imager during imaging (FMC movement), translational speed is reduced for closely spaced ROIs e.g. as illustrated by FIG. 5A for positions F-I.

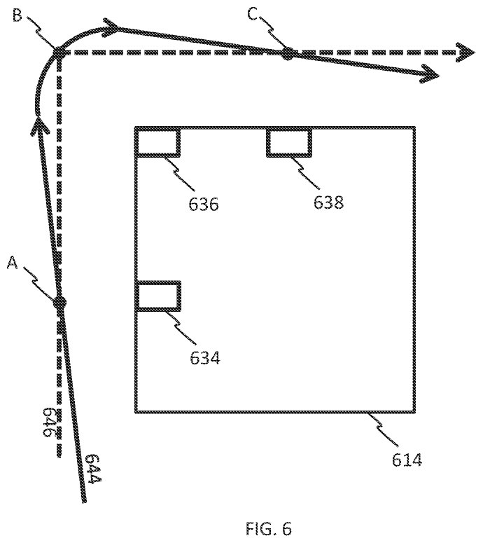

FIG. 6 is a simplified schematic of an imaging trajectory 644 with respect to an object to be inspected 614, according to some embodiments of the invention.

In some embodiments, ROIs 634, 636, 638 are distributed around object 614, resulting in imaging positions A, B, and C. In some embodiments, a path of the imager, in inspecting the ROIs 634, 636, 638 involves a change in direction.

In some embodiments, when an inspection plan is generated, the path of the imager with relationship to object 614 is changed. For example to reduce acceleration/s experienced by the imager during change/s in direction. The reduction in acceleration, for example, potentially decreasing image degradation e.g. degradation due to induced vibrations and/or enabling higher translational speeds for the imager.

For example, in some embodiments, a path 646 directly connecting imaging positions A, B, C, is replaced by a path 644 including additional path coordinates. Path 644 has smoothing to change/s in direction e.g. the change in direction required in transitioning between points A, B, and C.

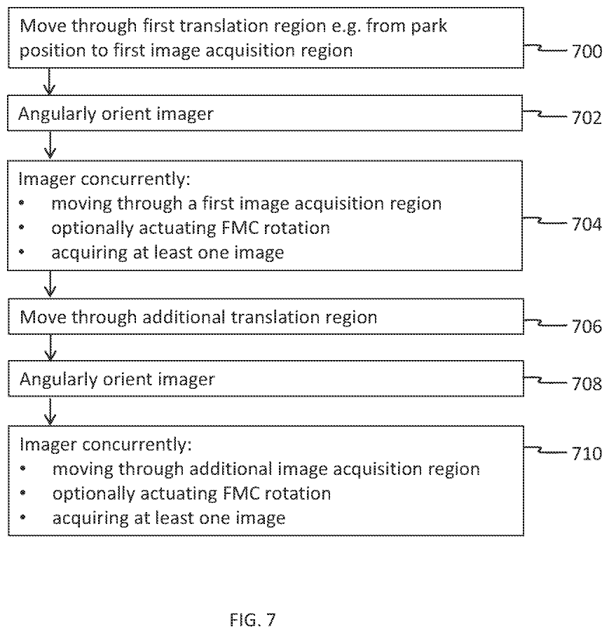

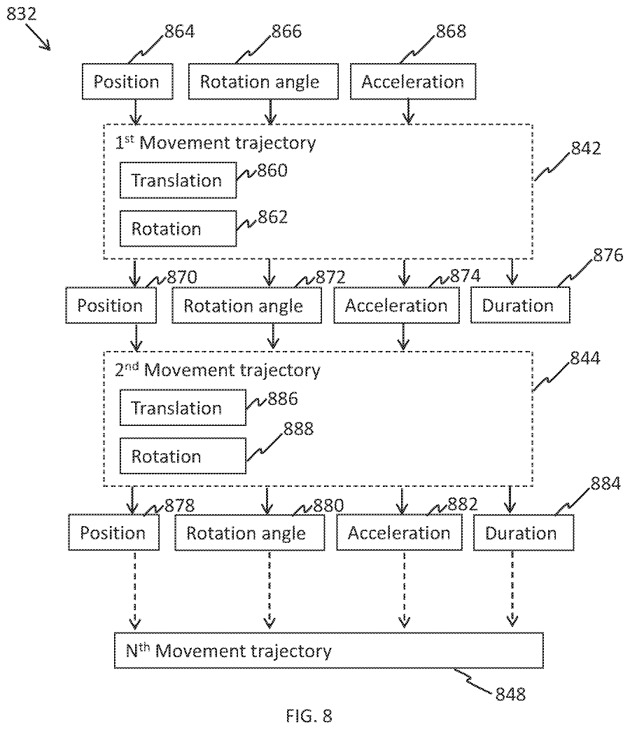

FIG. 7 is a flowchart of a method of inspection of an object, according to some embodiments of the invention.

At 700, in some embodiments, the imager is moved through a first translation region to a first acquisition region. For example, movement is from a “home” or “park” position to a position with at least one ROI of the object within the FOV of the imager. For example, referring back to FIG. 5B, movement is from position A to position B, with first ROI 534 being captured by imager 502 from within FOV 558.

Although, in this method, movement is described only of the imager, it is to be understood that this refers to relative movement between the imager and the object to be inspected. In some embodiments, only the object to be inspected moves with respect to a stationary imager and/or both the object and the imager move.

At 702, in some embodiments, the imager is angularly orientated (e.g. rotated) during translational movement of the imager through the first translation region between positions A and B. Alternatively, or additionally, in some embodiments, rotation of the imager is before translational movement of the imager starts and/or during pause/s in translation of the imager.

In some embodiments, the imager is angularly orientated so that FOV 558 captures ROI 534 sooner e.g. earlier in the translation between positions (e.g. between position A and B).

At 704, in some embodiments, during an acquisition region, the imager collects at least one image during movement of the imager e.g. during translation between positions (e.g. between positions B and C). Optionally, in some embodiments, the imager concurrently performs FMC. For example, changing angular orientation, e.g. rotating around an axis which is non-parallel to a direction of the translational movement. For example, as described elsewhere in this document, in some embodiments, during rotational (FMC) and translational movement, the imager acquires one or more images of the FOV.

At 706, in some embodiments, the imager moves through an additional translation region, for example, between positions C and D. For example, from a position at which imaging of first ROI 534 finished to a position for which second ROI 536 appears in the FOV of imager 502.

At 708, in some embodiments, the imager is angularly orientated (e.g. rotated) during translational movement of the imager through the first translation region between positions C and D. Alternatively, or additionally, in some embodiments, rotation of the imager is before translational movement of the imager starts and/or during pause/s in translation of the imager. In some embodiments, angularly orientating at this stage resets and/or prepares the imager for imaging of second ROI 536.

At 710, in some embodiments, imaging and/or movement of the imager includes one or more features as described regarding step 704.

In some embodiments, additional ROI/s are then imaged (e.g. third ROI 535 and/or fourth ROI 538 FIG. 5B). After which, in some embodiments, the imager is returned to the home position.

In some embodiments, the object is moved or rotated to allow inspection of other parts of the object that were not accessible to the first trajectory. In some embodiments, the object is then moved with respect to the imager and inspection is carried out on another object.

FIG. 8 is a simplified schematic block diagram showing variables for generation of an inspection plan 832, according to some embodiments of the invention.

In some embodiments, a single inspection plan is generated for a plurality of individual objects e.g. the objects having the same object model (e.g. model as described regarding step 300, FIG. 3A) e.g. objects belonging to a production lot.

In some embodiments, inspection plan 832 includes a plurality of movement trajectories. For example, a first movement trajectory 842, a second movement trajectory 844, up to an Nth movement trajectory 848. In some embodiments, a movement trajectory includes translational movement and/or rotational movement of the imager.

In some embodiments, inspection plan 832 is divided into movement trajectories by the portions of a total trajectory of the imager for which the imager is acquiring images. The movement trajectories may include imaging movement trajectories and non-imaging (also herein termed “translational”) movement trajectories. In some embodiments, imaging movement trajectories are moved along while the imager is acquiring images and/or while an ROI is within a FOV of the imager. In some embodiments, non-imaging trajectories are moved along while the imager is moving between imaging regions and is not acquiring images, or the imaging does not place limitations on movements of the imager (e.g. low quality images and/or images not of the ROIs are acquired).

For ease of description FIG. 8 illustrates only movement and position variables. However, inspection plan 832, in some embodiments, also includes imaging variables, for example, for each imaging movement trajectory. The exemplary imaging variables are, for example, as described regarding imaging parameter/s 330 FIG. 3B.

In some embodiments, inspection plan 832 is generated using input and output variables for the movement trajectories, and variables of the movement trajectories themselves.

In some embodiments, each movement trajectory includes translational movement and optionally rotational movement. For example, translation 860, rotation 862 of first movement trajectory 842 and translation 886, rotation 888 of second movement trajectory 844.

In some embodiments, inputs to a movement trajectory include one or more of: position, rotation angle, and acceleration of the imager prior to the movement trajectory. For example, position 864, rotation angle 866, and acceleration 868 are inputs to first movement trajectory 842. For example, position 870, rotation angle 872, and acceleration 874 are inputs to second movement trajectory 844.

In some embodiments, a plurality of positions 864 of the imager during imaging are inputs to generation of movement trajectory/ies and/or translational trajectory/ies. In some embodiments, position of the imager is adjusted e.g. smoothed e.g. to reduce accelerations on the imager whilst changing direction. For example, as described regarding FIG. 6.

In some embodiments, outputs of a movement trajectory include, after the movement trajectory, one or more of: position, rotation angle, acceleration and duration of the movement trajectory. For example, position 870, rotation angle 822, acceleration 844 and duration 876 are outputs of first movement trajectory 842. For example, position 878, rotation angle 880, acceleration 882, and duration 884 are outputs of second movement trajectory 844.

In some embodiments, one or more outputs of a movement trajectory form one or more inputs to a subsequent movement trajectory. For example, outputs 870, 872, 874 of first movement trajectory 842 are inputs to second movement trajectory 844.

In some embodiments, inspection plan 832 is generated by optimizing one or more variables of the inspection plan. In some embodiments, the optimizing is for an object including individual object parameters. In some embodiments, the generating of the inspection plan includes as an input (or limit) the required image data of the object for inspection and a model of the object of inspection (e.g. including one or more features as illustrated and/or described regarding required image data 324, model 326 and inspection plan 332, FIG. 3B).

In some embodiments, imaging parameters also form variables for generation of inspection plan 832. For example, shutter speed and/or illumination pulse duration and/or power. For example, whether one or a plurality of images are collected. For example, an extent to which a plurality of images overlap with each other.

In an exemplary embodiment, one or more variables of inspection plan 832 is used to optimize a total duration of inspection plan 832. Which, in some embodiments, is equal to the sum of the durations of all of the imaging trajectories (e.g. duration 876, duration 844, and durations of imaging trajectories up to and including Nth movement trajectory 848).

In some embodiments, one or more additional non-imaging movement trajectory segments are inserted before the entry and/or following the exit of imaging trajectory segments. For example, to smooth an imaging trajectory segment and/or reduce acceleration/s.

In some embodiments, when generating the inspection plan, one or more variables is limited and/or set.

For example, in some embodiments, position of the imager is limited by dimensions of the inspection object, and/or imager apparatus (e.g. in some embodiments, including dimensions of a robotic arm configured to move the imager) and/or by a space in which the object and imager are located.

For example, in some embodiments, acceleration and/or speed is limited by the weight and/or actuators of the physical system and/or how well system vibrations (e.g. associated with accelerations) are damped.

For example, in embodiments moving an illumination assembly along with the imager, the weight and/or size and/or shape of this “payload” limits their movement.

For example, in some embodiments, one or more imaging parameters are limited. For example, one or more of: imager FOV, shutter speed, illumination pulse duration and/or strength.

For example, in some embodiments, object characteristic/s e.g. reflectance limit illumination for example, a low reflectance object, in some embodiments, requires longer and/or higher power illumination pulses for inspection.

In some embodiments, imaging variables, for imaging movement trajectories are used in optimization to generate the inspection plan. In some embodiments, a limit to the optimization is the required image data of ROIs.

For example, in some embodiments, acquired image data is corrupted e.g. by one or more of: blur, defocusing, distortion and noise in the images acquired, with increasing translational speed. Corruption effects, in some embodiments, do not affect image data size e.g. number of bytes.

For example, in some embodiments, acquired image data is improved by increased exposure and/or strobe time. In some embodiments, this time is increased by compensating for one motion of the imager with another motion of the imager, e.g. by FMC rotation.

### Exemplary Effect of Distance Between the Imager and Object

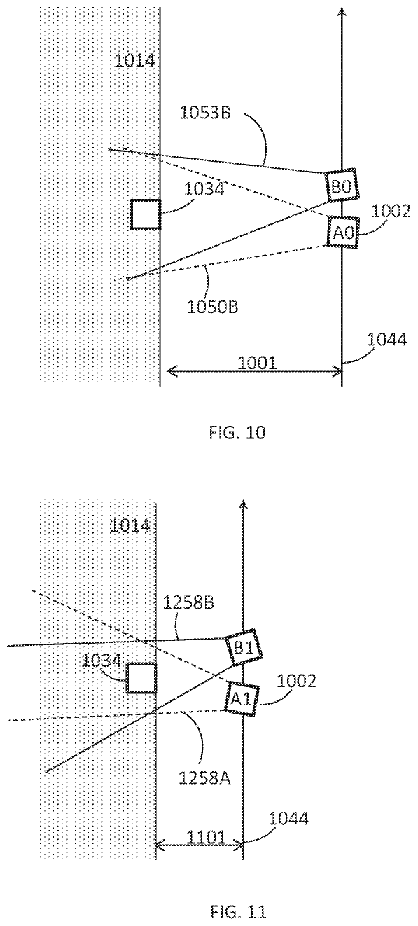

FIGS. 10-11 are simplified schematics illustrating movement of an imager 1002 during image acquisition of an object of manufacture 1014, according to some embodiments of the invention.

In some embodiments, FIGS. 10-11 illustrate imaging, with imager 1002 traveling on a same translational movement path 1044 at a same linear speed along the path.

FIG. 10 illustrates an embodiment wherein imager 1002 is at a first distance 1001 from object 1014. FIG. 11 illustrates an embodiment with imager 1002 is at a second distance 1101 from object 1014, wherein first distance 1001 is larger than second distance 1101.

Having imager 1002 closer to ROI 1034, in some embodiments, magnifies ROI 1034 in collected images e.g. as ROI 1034 is captured by more pixels of the imager detector.

Alternatively, in some embodiments, imager 1002, has a telecentric lens which, in some embodiments reduces dependence of a size of the ROI in collected images on the distance between the imager and the ROI.

In some embodiments, linear movement (e.g. as illustrated by arrow 1044) of the imager, for both FIG. 10 and FIG. 11 is at the same speed.

In FIG. 10 and FIG. 11, in some embodiments, FMC rotational movement maintains ROI 1034 in a same region of FOV of imager 1002. Insofar as translational movement along trajectory 1044 is at the same speed, adjustment for reduced distance between imager 1002 and ROI 1034 in FIG. 11 may result in faster angular movement of imager 1002 and a longer angular stroke of the FMC rotation during the same exposure time.

FIG. 10 and FIG. 11, in some embodiments, illustrate a potential benefit of increased distance between the imager and the FOV, of reduced required FMC motion speed and/or total FMC angular movement. Increased distance, in some embodiments, is enabled by longer focal length lenses in imager 1002. In some embodiments, however, increasing focal length of the imager results in increased bulk and/or cost of imaging equipment.

It should be noted that FIG. 10 and FIG. 11, in some embodiments, show larger FMC movement and/or a larger distance travelled along trajectory 1044 while imaging than some exemplary embodiments of object inspection. Some exemplary speed/s and/or distance/s are described in the overview section of this document.

### Exemplary Calibration

FIG. 9 is a flow chart of a method of determining FMC movement, according to some embodiments of the invention.

At 900, in some embodiments, an inspection plan for an object type is received.

In some embodiments, the inspection plan is a partial inspection plan. In some embodiments, for example, the inspection plan lacks FMC movement. In some embodiments, the inspection plan has been generated based on the assumption that FMC movements will be used during image acquisition at ROIs. For example, the inspection plan, in some embodiments, if it were implemented, would provide images lacking sufficient quality for inspection of the object.

In some embodiments, the inspection plan includes a plurality of positions in space of the imager e.g. imaging positions. In some embodiments, the inspection plan includes a path in space, optionally with time, of the imager. In some embodiments, the inspection plan includes actuator control commands for movement of the imager e.g. to effect such a path. For example, commands for actuators of a robotic system configured to move the imager (e.g. as illustrated in FIG. 16). In some embodiments, the inspection plan includes illumination pulse timing and/or power e.g. for ROI/s and/or image/s to be acquired.

In some embodiments, the inspection plan (e.g. lacking FMC movement) is generated for an object to be inspected by selecting a sequence of ROIs to be inspected and then determining a maximal speed trajectory of the imager given required speeds past ROIs for image acquisition.

At 902, in some embodiments, a speed of an imaging movement trajectory as the imager moves past an ROI is determined e.g. calibrated.

In some embodiments, the speed is determined by moving the imager linearly (e.g. without rotation of the imager) according to linear movements of the inspection plan while the imager collects image/s. For example, at least one image of an ROI. In some embodiments, the imager collects image/s of each ROI that is to be inspected, according to the inspection plan.

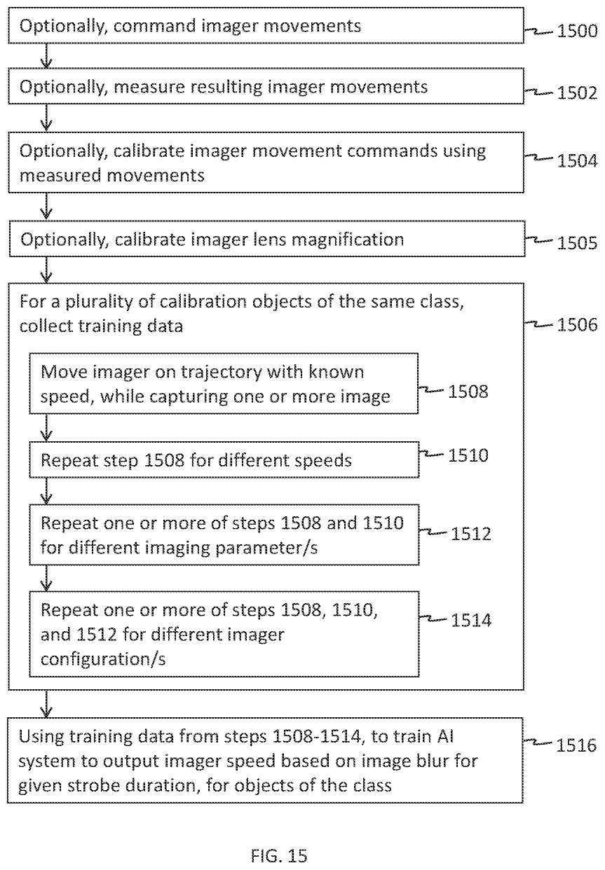

These images, in some embodiments, are used to determine actual speed of movement of the imager, using, for example, artificial intelligence (AI) training (e.g. the AI training as described regarding one or more steps of FIG. 15). For example, blur appearing in the acquired images is used to determine the speed. In some embodiments, AI training (e.g. as described regarding FIG. 15) is performed on a platform featuring a similar imager (e.g. camera and/or camera lens/es) as the local inspection system. In some embodiments, the local system retrieves AI training information. Alternatively or additionally, in some embodiments, AI training is performed on the local inspection system.

At 904, in some embodiments, distances between the imager and the ROI at different portions of the trajectory are determined for example, position of the imager with respect to the ROI when the image is acquired e.g. for each ROI of the inspection plan.

In some embodiments, distance is determined using one or more features of the method of FIG. 13.

Alternatively or additionally to determining the distance between the imager and the ROI from image blur when an image is collected during rotation of the imager, in some embodiments, the distance between the imager and the ROI is determined by calibrating dependence of imager magnification on the distance. For example, the imager is used to focus on a known sized feature (or features), the known size/s then being used to calibrate distance between the imager and the object and/or ROI. In some embodiments, imager focus is used, with imager magnification being calibrated to distance between the imager and object being focused on by the imager and/or when the object includes a scale.

At 906, in some embodiments, FMC movement is determined, based on the determined speed, distance and the exposure time. For example, the FMC being sufficient to offset image degradation of the ROI (and/or of a portion of the ROI e.g. in embodiments collecting multiple images during transition past an ROI) associated with the speed of movement, for the given exposure time. In some embodiments, FMC is limited by maximum allowed FMC accelerations as, in some embodiments, above certain accelerations FMC motion generates vibrations, degrading acquired image quality.

In some embodiments, steps 902-906 are performed for each ROI of the object.

In some embodiments, e.g. wherein the same system is used for inspection (e.g. same imager and/or robotic arm) calibration performed on a local system (e.g. according to FIG. 9) is used in local calibration of another local system. For example, for a same object placed in a same position with respect to the robotic arm.

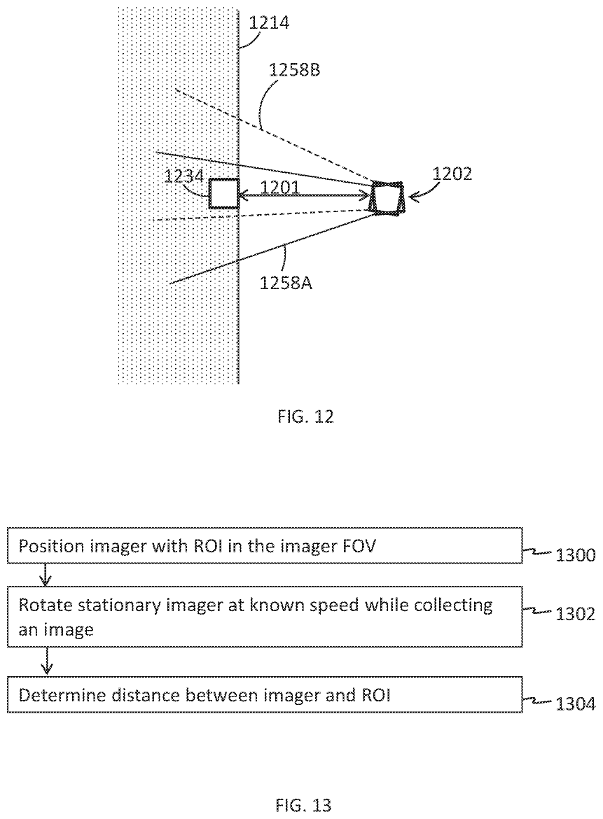

FIG. 12 is a simplified schematic illustrating determining distance 1201 between an imager 1202 and a ROI 1234, according to some embodiments of the invention.

FIG. 13 is a method of determining distance between an imager and a ROI, according to some embodiments of the invention.

At 1300, the imager (e.g. imager 1202 FIG. 12) in some embodiments, is positioned at an imaging position (“imaging position” e.g. as described elsewhere in this document e.g. an imaging position corresponding to an inspection plan) with the ROI is within the imager FOV (e.g. referring to FIG. 12 wherein the ROI 1234 of object 1214 is within imager FOV 1258A).

At 1302, in some embodiments, the imager, while otherwise stationary, rotates at a known angular rotational speed, while collecting an image of an ROI. For example, as illustrated in FIG. 12 showing rotation of imager 1202; imager FOV changing from FOV 1258A to FOV 1258B during the rotation. In some embodiments, rotation illustrated in FIG. 12 is exaggerated. In some embodiments, actual FMC rotation is 0.5-3 degrees, or lower or higher or intermediate ranges or angles.

In some embodiments, for example, during calibration, step 1302 is performed at each imaging position e.g. for each ROI for which, before image acquisition, the imager is allowed to come to a full stop before step 1302 is begun.

At 1304, in some embodiments, blur in image/s collected during the rotational movement of the imager is used to determine a distance between the ROI and the imager, for example, for each ROI.

In some embodiments, rotational movement of the imager produces blur in image/s collected during the rotation. The magnitude of the blur, in some embodiments, for a given rotation speed, scales linearly with the ROI to imager distance. In some embodiments, blur, with respect to a known size of a feature of the object being imaged, herein termed “absolute value of blur” is linearly related (the relationship related to rotation speed and/or shutter speed and/or illumination pulse duration) to separation between the imager and the object. In some embodiments, a known speed of rotation (e.g. as determined by rotational encoders for example, as described with reference to FIG. 16) is used along with the image blur to determine the distance between the ROI and the imager, for example, the distance between the ROI and the imager rotation axis.

In some embodiments, the imager includes non-telecentric lens/es to acquire image/s, such that object magnification changes with object distance.

In some embodiments, the imager includes telecentric lens/es to acquire image/s, such that, in the acquired image/s, object scale remains fixed within the lens DOF.

For both telecentric and non-telecentric lensed imagers, the amount of blur scales with the distance between the ROI and the imager.

Optionally, in some embodiments, one or more known dimensions are used in determining the distance, for example, in determining the absolute value of blur. In some embodiments, known real world dimensions of one or more portions of the object and/or ROI are used. In some embodiments, one or more size references is attached (e.g. adhered) to the object of manufacture e.g. during generation of the inspection plan.

FIG. 14 is a flow chart of a method of object inspection, according to some embodiments of the invention.

At 1400, in some embodiments, an inspection plan is received for an object of manufacture.

In some embodiments, the inspection plan is generated remotely from the local inspection apparatus and then sent to and/or retrieved by the local system.

At 1402, in some embodiments, the local inspection system (e.g. including the local imager and/or apparatus for moving it) is calibrated.

In some embodiments, for example, a sufficiently precise object model is available, and the system derives desired FMC motion using the object model.

In some embodiments, calibration performed according to one or more features in and/or described regarding FIG. 9 is used. This may be done, for example, when a sufficiently precise object model is not available, and/or when manual inspection plan preparation is desired. In a manual inspection plan, a user directly specifies portion/s of an inspection plan.

In some embodiments, a manual inspection plan includes a partial inspection plan as provided by a user. The partial inspection plan may be, e.g. as described in the overview section of this document.

At 1404, in some embodiments, the inspection plan is adjusted, based on the local system calibration.

At 1406, in some embodiments, the object of manufacture is inspected using the local system, according to the adjusted inspection plan. In some embodiments, a plurality of the objects are inspected e.g. sequentially.

FIG. 15 is a flow chart of a method of system calibration, according to some embodiments of the invention.

At 1500, optionally, in some embodiments, imager movements are commanded (e.g. by a processor, e.g. processor 110 FIG. 1). In some embodiments, the movements include different speeds and/or trajectories. In some embodiments, movements are of the imager at different linear velocities.

At 1502, optionally, in some embodiments, the imager movements resulting from commands at step 1500 are measured. For example, using an interferometer with a retroreflector of the interferometer replacing the imager on the imaging system or a retroreflector attached to the imager.

At 1504, optionally, in some embodiments, imager movement commands are calibrated using measurements collected at step 1502. For example, imager movement commands are adjusted, based on the measurements.

At 1505, optionally, in some embodiments imaging lens magnification is calibrated with respect to object distance using one or more dimensional reference targets. Object distance is then inferred based on calculated magnification of object features having known dimension/s.

Optionally, in some embodiments such features are artificially produced by affixing suitable fiducials to the test object.

In some embodiments, steps 1500-1504 are not performed e.g. as imager commands are considered to sufficiently accurately determine imager movement. For example, other steps of the method of FIG. 15 are relied on to calibrate movement and/or position of the imager. In some embodiments, step 105 is not performed.

At 1506, in some embodiments, for a plurality of calibration objects of the same class of objects, training data is collected. Collecting the training data includes performing one or more of steps 1508-1514, for a plurality of calibration objects:

At 1508, for example, the imager is moved on a trajectory with a known speed, while capturing one or more images of a training object.

At 1510, for example, step 1508 is repeated for different imager movements e.g. different imager movement speeds.

At 1512, for example, steps 1508 and 1510 are repeated for different imaging parameter/s. For example, different illumination strobe durations and/or for different shutter speeds.

At 1514, for example, steps 1508-1512 are repeated for different imager configuration/s. For example, in some embodiments, the imager lens is replaced with a narrow angle (e.g. longer focal length) lens. For example, alternatively or additionally to performing steps 1508-1512 with a narrow angle lens, in some embodiments, the imager lens is replaced with a telecentric lens. Potentially, a narrow angle lens and/or telecentric lens reducing effect of distance between the ROI and imager on image magnification.

At 1516, in some embodiments, an Artificial Intelligence (AI) system is trained, using the data acquired in steps 1508-1514, to infer, from image blur and strobe duration (and/or shutter speed) a speed of the imager during image acquisition.

In some embodiments, training is performed for a class of objects. In some embodiments, the class includes objects which have similar appearance, e.g. PCB's of different designs, e.g. jet engine blades of different shapes and/or sizes.

Alternatively, in some embodiments, a class includes objects which differ in their appearance. In some embodiments, the more varied the class, the larger set of training objects is needed to train the system and/or the longer computation times required for training the system.

In some embodiments, motion blur introduces discrepancy between along-motion object features and cross-motion object features in acquired images. In some embodiments, training involving observation of such discrepancy/is, generates indication/s as to which features to assess in acquired images, features e.g. such as edge, textures, dots, lines.

In some embodiments, AI system training includes using one or more machine learning methods (e.g. support vector machine (SVM) method/s), ordinated classification method, Convolutional Neural Networks).

In some embodiments, imager speed is inferred from the motion blur using direct image processing methods as known in the art. Such methods may become useful at relatively long exposures, when motion blur of cross-motion features becomes excessive in relation to scan-direction features.

In some embodiments, targets containing dimensional references are affixed to the test object to assist in assessing the absolute amount of blur, e.g. in cases for which the object itself lacks suitable features.

In some embodiments, determining speed from acquired images includes one or more features as described and/or illustrated in one or more of the below listed references which are herein incorporated by reference in their entirety:

Vehicle Speed Detection and Identification from a Single Motion Blurred Image by Huei-Yung Lin et al, 2005 Seventh IEEE Workshops on Applications of Computer Vision (WACV/MOTION'05), Volume 1

Vehicle Motion Detection using CNN by Yaqi Zhang et al, CS231n: Convolutional Neural Networks for Visual Recognition, Reports 2017

### Exemplary Movement of Imaging Assembly

FIG. 16 is a simplified schematic of an inspection system 1600, according to some embodiments of the invention.

In some embodiments, system 1600 includes an arm 1624 which includes a plurality of segments 1634, 1636, 1638, 1640 sequentially coupled by a plurality of joints 1626, 1628, 1630, 1632. In some embodiments, arm 1624, by movement of segments 1634, 1636, 1638, 1640 with respect to each other, is configured to move an imaging assembly 1602. Imaging assembly 1602, in some embodiments, includes one or more features as illustrated in and/or described regarding imaging assembly 102 FIG. 1. For example, arm 1624 is configured to move an imager of imaging assembly 1602 with concurrent linear movement and rotation (e.g. as described elsewhere in this document).

In some embodiments, imaging assembly 1602 includes an imager with a FOV 1650 and, optionally, an illumination assembly. In some embodiments, illumination assembly includes a plurality of illuminators, for example a plurality of independently controllable illuminators.

In some embodiments, system 1600 is controlled by a controller hosted by a processor (not illustrated) e.g. including one or more features as illustrated and/or described regarding processor 110, FIG. 1. For example, in some embodiments, the system controller issues commands to control imaging parameter/s (e.g. image acquisition timing and/or exposure duration) of imager 1602 such as. In some embodiments, the system controller issues commands to control illumination parameter/s e.g. strobe timing and/or duration and/or intensity for one or more illuminators.

In some embodiments, imaging assembly 1602 is attached and/or part of a distal-most, first segment 1634 of arm 1624. In some embodiments, one or more of the joints is a pivot joint. Alternatively or additionally, in some embodiments, one or more of the joints is a rotational joint.

In some embodiments, rotation of imager 1602 with respect to object 1614 e.g. during FMC movement, is effected by rotation of portion/s about one or more of the rotational axes 1644, 1646, 1642.

In some embodiments, rotation of the imager is effected by rotation about an axis geometrically close to the imager and/or close to a position of a center of mass of the imager e.g. by rotation of a segment to which the imager is connected about axis 1642 and/or by rotation of a segment immediately adjacent such a segment. A potential benefit being reduction of parallax effects in peripheral region/s of acquired images. A potential benefit of rotation close to the imager center of mass being reduced force required for rotational movement and/or reduced vibrations produced by the rotational movement.

Additionally or alternatively, in some embodiments, rotation of the imager is effected by rotation about an axis at larger separation between the imager and the rotation axis. For example, by rotation of a segment which is not the robotic arm segment to which the imager is connected e.g. axis 1644. A potential benefit being reduced speed of angular rotation required at the rotation axis e.g. rotation as effected by one or more actuators e.g. of the robotic arm.

Additionally or alternatively, in some embodiments, rotation is effected by rotation of the object, e.g. about axis 1646.

In an exemplary embodiment, a first joint 1632 connects a first segment 1634 to a second segment 1636, first segment 1634 form distal end of arm 1624. In an exemplary embodiment, first segment 1634 is both pivotable at joint 1632 and rotatable about a first rotation axis 1642. In some embodiments, FMC motion of imaging assembly 1602 is effected during image acquisition by pivoting of first segment 1634 with respect to joint 1632 and/or rotating of first segment with respect to rotation axis 1642. Additionally or alternatively, in some embodiments, FMC movement of the imaging assembly is effected by movement (e.g. pivoting and/or rotation) of a plurality of segments of arm 1624 e.g. to result in the desired movement of the imaging assembly.

In some embodiments, a second joint 1630 connects second segment 1636 to a third segment 1638. In an exemplary embodiments, second joint 1630 is a pivot joint. In some embodiments, a fourth segment 1640 is connected to third segment 1638 by a third joint 1628. In an exemplary embodiment, third joint 1628 is a pivot joint. In some embodiments, fourth segment 1642 is attached to a stand 1626 via a fourth joint 1642. In an exemplary embodiment, fourth joint 1642 is a rotational joint which is configured to rotate fourth segment 1628 about a second rotation axis 1644.

In some embodiments, an object of manufacture 1614 is supported by stand 1615 which, in some embodiments, is configured to move object 1614 e.g. to rotate object 1614 about a third rotation axis 1646. Additionally or alternatively, in some embodiments, stand 1615 is configured to move object 1614 laterally in one or more directions.

In some embodiments, movement of segments with respect to each other is measured. For example, in some embodiments, rotational movement (e.g. at one or more of axes 1642, 1644, 1646) is measured, e.g. using one or more rotational encoders.

### General

It is expected that during the life of a patent maturing from this application many relevant object inspection and/or imaging and/or robotic movement technologies will be developed and the scope of the terms object inspection and/or imaging and/or robotic movement is intended to include all such new technologies a priori.

As used herein the term “about” refers to ±20%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of inspecting an object of manufacture, said method comprising:
receiving:
a model of said object of manufacture, said model including one or more feature of a region of interest (ROI) of said object of manufacture, and
inspection requirements including a specification of required quality of image data of said ROI;
moving an imager with respect to said object of manufacture, while acquiring at least one image of said ROI using said imager, wherein said moving is controlled so that said at least one image provides said required quality of image data of said ROI;
extracting one or more feature of said ROI, from said at least one image; and
comparing said one or more feature of said ROI with a corresponding one or more feature of said model.

2-34. (canceled)

35. The method according to claim 1, wherein said object of manufacture comprises a plurality of ROIs; and
wherein said receiving, said moving, said extracting, and said comparing are performed for each of said plurality of ROIs.

36. The method according to claim 35, wherein said imager is moved along a path comprising a plurality of imaging portions, each imaging portion corresponding to an individual ROI of said plurality of ROIs and describing a path followed by said imager while acquiring said at least one image of said individual ROI.

37. The method according to claim 36, wherein said path comprises at least one translation portion describing a path of said imager connecting two of said plurality of imaging portions.

38. The method according to claim 37, wherein said imager is accelerated during said translation portion and decelerated prior to arrival at a subsequent imaging portion.

39. The method according to claim 37, wherein said two imaging portions have different directions, wherein said at least one translation portion of said path is selected to reduce acceleration of change in direction of said imager between said two imaging portions.

40. The method according to claim 1, wherein said moving comprises performing Forward Motion Compensation (FMC) moving of said imager with respect to said object of manufacture.

41. The method according to claim 40, wherein said moving comprises moving in a first direction while performing FMC movement which comprises rotating said imager with respect to said object about a non-parallel axis to said first direction, to increase a time for which said ROI is at least partially within a FOV of said imager.

42. The method according to claim 1, comprising:
receiving one or more imaging parameter for operation of said imager;
determining one or more parameter of motion, using said one or more imaging parameter; and
wherein said moving is according to said one or more parameter of motion.

43. The method according to claim 42, wherein said one or more imaging parameter comprises an illumination parameter.

44. The method according to claim 43, wherein said imager comprises one or more illuminator, which illuminates according to said illumination parameter.

45. The method according to claim 1, comprising:
receiving one or more parameter of motion, wherein said moving is according to said one or more parameter of motion;
determining one or more imaging parameter, using said one or more parameter of motion; and
wherein said acquiring is according to said one or more imaging parameter.

46. The method according to claim 45, wherein said one or more imaging parameter comprises one or more of illumination intensity, illumination pulse duration, illumination direction, imager shutter speed.

47. The method according to claim 1, wherein said moving comprises moving said imager.

48. The method according to claim 1, wherein said moving comprises moving said object of manufacture.

49. The method according to claim 1, comprising receiving an inspection plan comprising one or more imaging parameter and/or one or more parameter of motion;
wherein said imaging and said moving are according to said inspection plan.

50. The method according to claim 49, comprising changing said inspection plan, based on one or more of:
said one or more image;
said extracting;
said comparing; and
data received from one or more sensor.

51. The method according to claim 1, wherein said at least one image comprises a plurality of overlapping images, wherein at least a portion of said ROI is captured in one or more of said plurality of overlapping images.

52. The method according to claim 51, wherein at least a portion of said ROI is captured in each of said plurality of overlapping images.

53. The method according to claim 51, wherein said imaging is using at least two different imaging modes.

54. The method according to claim 53, wherein each said imaging mode includes a plurality of imaging parameters, wherein said at least two different imaging modes have one or more different imaging parameter.

55. The method according to claim 54, wherein said plurality of imaging parameters include two or more of; an illumination direction, an illumination intensity, an illumination pulse duration, and an imager shutter speed.

56. The method according to claim 49, comprising generating said inspection plan, the generating comprising:
receiving a path with time for movement of an imager, said path for imaging a ROI of said object of manufacture using said imager;
determining speed of said path with time at an imaging region of said path for said ROI;
determining distance between said path and said ROI at said imaging region;
determining Forward Motion Compensation (FMC) rotational movement of said imager at said imaging region for said ROI, using said speed and distance, said inspection plan including said path with time and said FMC movement.

57. The method according to claim 49, comprising generating said inspection plan, the generating comprising:
receiving a model of said object of manufacture, said model including one or more feature of one or more ROI;
receiving inspection requirements including a specification of a required quality of image data of said one or more ROI;
generating, based on said required quality of image data, and said one or more feature of said one or more ROI, an inspection plan comprising:
movement of said imager with respect to said object of manufacture; and
one or more imaging parameter.
